(19) United States
(12) Patent Application Publication
(10) Pub. No.: US 2026/0061988 A1
(43) Pub. Date: Mar. 5, 2026

(54) PARKING EXIT ASSIST DEVICE AND PARKING EXIT ASSIST METHOD FOR VEHICLE

(71) Applicant: TOYOTA JIDOSHA KABUSHIKI KAISHA, Toyota-shi (JP)

(72) Inventors: Takuya NAKAGAWA, Okazaki-shi (JP); Tomohito Higuma, Toyota-shi (JP); Tatsuya Ishiguro, Toyota-shi (JP)

(73) Assignee: TOYOTA JIDOSHA KABUSHIKI KAISHA, Toyota-shi (JP)

(21) Appl. No.: 19/239,197

(22) Filed: Jun. 16, 2025

(30) Foreign Application Priority Data
Sep. 3, 2024 (JP) 2024-151194

(51) Int. Cl. B60W 30/00; B60W 50/14

(52) U.S. Cl. CPC B60W 30/00; B60W 50/14; B60W 2520/06; B60W 2540/10; B60W 2540/12; B60W 2540/16

(57) ABSTRACT

A parking exit assist device for a vehicle is configured to execute a parking exit assist control for moving a parked vehicle to a predetermined exit completion position along a travel path stored in advance. The parking exit assist device is configured to, when a specific condition is satisfied before the vehicle under the parking exit assist control reaches the exit completion position, notify an occupant of the vehicle that the parking exit assist control is allowed to be ended by a predetermined operation, and end the parking exit assist control when the predetermined operation is detected. The specific condition is a condition that there is no turning position on the travel path from a current position of the vehicle to the exit completion position and the distance from the current position of the vehicle to the exit completion position is equal to or less than a predetermined threshold.

### CROSS-REFERENCE TO RELATED APPLICATION

This application claims priority to Japanese Patent Application No. 2024-151194 filed on Sep. 3, 2024. The disclosure of the above-identified application, including the specification, drawings, and claims, is incorporated by reference herein in its entirety.

### BACKGROUND

### 1. Technical Field

The present disclosure relates to parking exit assist devices and parking exit assist methods for vehicles.

### 2. Description of Related Art

For example, Japanese Unexamined Patent Application Publication No. 2023-046472 (JP 2023-04672 A) discloses a device configured to execute a parking exit assist control for setting a travel path along which a parked vehicle is moved to a target parking exit position and autonomously move the vehicle along the travel path. In the device described in JP 2023-046472 A, an end permission condition is that the vehicle traveling along the travel path has passed through a predetermined position where the vehicle is closest to an object. Until the end permission condition is satisfied, the parking exit assist control is continued even when an end request from the driver is detected. Once the end permission condition is satisfied, the parking exit assist control ends as soon as an end request from the driver is detected.

### SUMMARY

The device described in JP 2023-046472 A is intended for parking exit assistance in common public parking lots etc., and a travel path that is set when a vehicle exits a parking spot is often a relatively short distance. Path storage type parking exit assist devices have also been in practical use. These parking exit assist devices store a travel path followed by a vehicle when a driver manually maneuvers the vehicle to exit a parking spot, and autonomously move the vehicle along the stored travel path from the next time the vehicle exits the same parking spot.

In such path storage type parking exit assist devices, a travel path for assistance is complicated due to the presence of a turning position on the travel path etc., and the assist distance tends to be relatively long. The device described in JP 2023-046472 A allows the parking exit assistance to end in response to a predetermined operation once the vehicle has passed through the predetermined position, namely the position where the vehicle is closest to an object, during the parking exit assistance. In this case, the parking exit assistance may end at a timing not desired by the driver. Specifically, the parking exit assistance may end even though the remaining distance to an exit target position is long or even though there is a turning position etc. on the remaining travel path.

The present disclosure was made to solve the above issue, and an object of the present disclosure is to optimize the timing to end parking exit assistance.

A device according to the present disclosure is a parking exit assist device for a vehicle that is configured to execute a parking exit assist control for moving a parked vehicle to a predetermined exit completion position along a travel path stored in advance.

The parking exit assist device is configured to, when a specific condition is satisfied before the vehicle under the parking exit assist control reaches the exit completion position, notify an occupant of the vehicle that the parking exit assist control is allowed to be ended by a predetermined operation, and end the parking exit assist control when the predetermined operation is detected. The specific condition is a condition that there is no turning position on the travel path from a current position of the vehicle to the exit completion position and the distance from the current position of the vehicle to the exit completion position is equal to or less than a predetermined threshold. The turning position is a position where a direction of travel of the vehicle is changed.

A method according to the present disclosure is a parking exit assist method for a vehicle that is configured to execute a parking exit assist control for moving a parked vehicle to a predetermined exit completion position along a travel path stored in advance.

When a specific condition is satisfied before the vehicle under the parking exit assist control reaches the exit completion position, an occupant of the vehicle is notified that the parking exit assist control is allowed to be ended by a predetermined operation, and the parking exit assist control is ended when the predetermined operation is detected. The specific condition is a condition that there is no turning position on the travel path from a current position of the vehicle to the exit completion position and the distance from the current position of the vehicle to the exit completion position is equal to or less than a predetermined threshold. The turning position is a position where a direction of travel of the vehicle is changed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a hardware configuration of a parking exit assist device according to the present embodiment;

FIG. 2 is a schematic diagram showing a software configuration of the parking exit assist device according to the present embodiment;

FIG. 3 is a schematic diagram illustrating an example of travel path information for parking exit assistance; and

FIG. 4 is a flowchart illustrating a routine of a parking exit assist end process.

### DETAILED DESCRIPTION OF EMBODIMENTS

Hereinafter, a parking exit assist device and a parking exit assist method for a vehicle according to the present embodiment will be described with reference to the drawings.

### Hardware Configuration

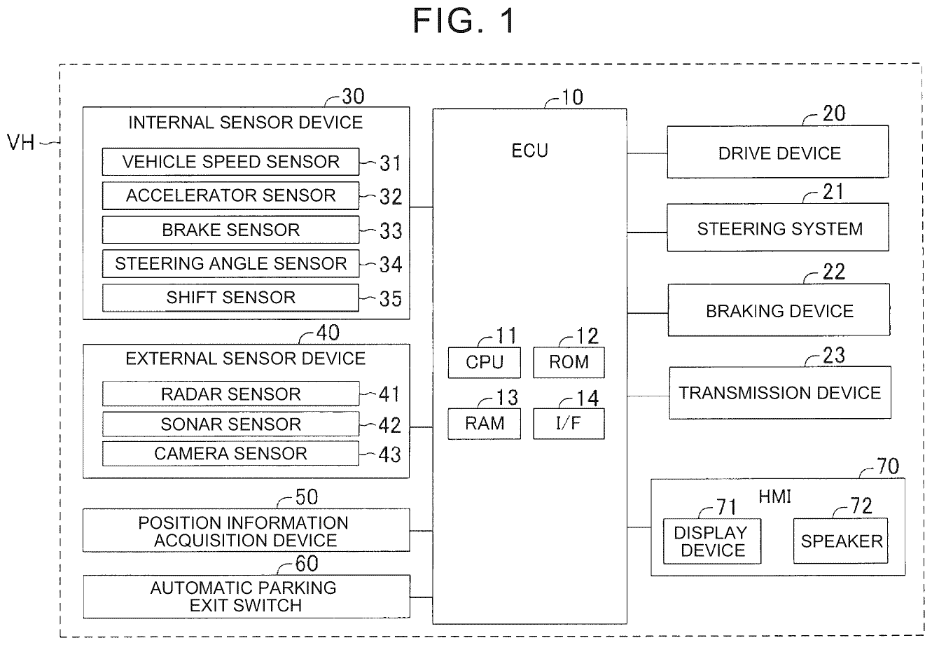

FIG. 1 is a schematic diagram illustrating a hardware configuration of a parking exit assist device 1 according to the present embodiment. The parking exit assist device 1 is mounted on a vehicle VH and includes an ECU (Electronic Control Unit) 10. The ECU 10 includes a CPU (Central Processing Unit) 11, a ROM (Read Only Memory) 12, a RAM (Random Access Memory) 13, and an interface device 14. The CPU 11 is a processor that executes various programs stored in the ROM 12. The ROM 12 is a nonvolatile memory that stores data etc. that are for the CPU 11 to execute various programs. The RAM 13 provides a working area into which various programs are loaded to be executed by the CPU 11. The interface device 14 is a communication device for communicating with an external device.

The ECU 10 is a central device that performs an automatic parking control for autonomously parking a vehicle VH in a parking spot, and an automatic parking exit control for autonomously moving a vehicle VH out of a parking spot where it is currently stopped. In the present embodiment, the automatic parking control and the automatic parking exit control are performed on a parking spot registered in advance by a driver, such as a parking spot of a home where the frequency of use is relatively high. Hereinafter, the parking spot that has been registered is referred to as “registered parking spot.” The target parking spot is limited to a parking spot whose parking space is defined by white lines etc. Any parking spot can be registered as a registered parking spot as long as the parking spot has a space that the vehicle VH is allowed to enter. The registered parking spot is registered in such a manner that travel path information is acquired when the driver manually maneuvers the vehicle VH to park in the parking spot or to exit the parking spot, and the acquired travel path information is stored in association with the position information of the parking spot. The automatic parking control of the vehicle VH to the registered parking spot and the automatic parking exit control from the registered parking spot are executed by moving the vehicle VH along a travel path stored in advance. Since the automatic parking control and the automatic parking exit control are basically the same process, the automatic parking exit control will be described below.

A drive device 20, a steering system 21, a braking device 22, a transmission device 23, an internal sensor device 30, an external sensor device 40, a position information acquisition device 50, an automatic parking exit switch 60, an HMI (Human Machine Interface) 70, etc. are communicably connected to the ECU 10.

The drive device 20 generates a driving force to be transmitted to the driving wheels of the vehicle VH. Examples of the drive device 20 include an electric motor and an engine. In the present embodiment, the vehicle VH may be any of a hybrid electric vehicle (HEV), a plug-in hybrid vehicle (PHEV), a fuel cell electric vehicle (FCEV), a battery electric vehicle (BEV), and an engine-driven vehicle. The steering system 21 applies a steering force to the wheels of the vehicle VH. The braking device 22 applies a braking force to the wheels of the vehicle VH. The transmission device 23 is configured to be selectively switched to a parking range in which the drive wheels are locked so as not to rotate, a reverse range in which the vehicle VH is caused to travel backward, a neutral range in which power transmission is cut off, and a drive range in which the vehicle VH is caused to travel forward.

The internal sensor device 30 is sensors that detect the state of the vehicle VH. Specifically, the internal sensor device 30 includes a wheel speed sensor 31, an accelerator sensor 32, a brake sensor 33, a steering angle sensor 34, a shift sensor 35, and the like. The wheel speed sensor 31 detects the traveling speed of the vehicle VH, that is, the vehicle speed. The accelerator sensor 32 detects the operation amount of an accelerator pedal, not shown, by a driver. The brake sensor 33 detects the operation amount of a brake pedal, not shown, by the driver. The steering angle sensor 34 detects a rotation angle of a steering wheel or a steering shaft, not shown, that is, a steering angle. The shift sensor 35 detects a shift position (parking P, reverse R, neutral N, drive D) of the transmission device 23. The internal sensor device 30 transmits the condition of the vehicle VH detected by the sensors 31 to 35 to the ECU 10 at a predetermined cycle.

The external sensor device 40 is sensors that recognize object information on an object around the vehicle VH. Specifically, the external sensor device 40 includes a radar sensor 41, a sonar sensor 42, a camera sensor 43, etc. The radar sensor 41 includes a millimeter wave radar and/or a lidar. The millimeter wave radar emits a radio wave in a millimeter wave band, and receives a reflected wave reflected by an object present in the emission range, thereby obtaining a relative distance, a relative velocity, and the like between the vehicle VH and the object. The lidar sequentially scans the pulsed laser beam having a wavelength shorter than the millimeter wave toward a plurality of directions, and receives the reflected light reflected by an object, thereby acquiring the shape of the object, a relative distance and a relative velocity between the vehicle VH and the object, etc. The sonar sensor 42 emits an ultrasonic wave and receives a reflected wave reflected by an object located in the emission range, thereby acquiring a relative distance and a relative velocity between the vehicle VH and the object, etc. The camera sensor 43 is, for example, a stereo camera or a monocular camera, and a digital camera having an image sensor such as a CMOS or a CCD can be used. The camera sensor 43 processes the captured image data to acquire the shape of the object, the relative distance and the relative velocity between the vehicle VH and the object, etc. The external sensor device 40 transmits the acquired target object data to the ECU 10 at predetermined cycles. Note that the external sensor device 40 does not necessarily have to include all of the radar sensor 41, the sonar sensor 42, and the camera sensor 43, and may include, for example, only the camera sensor 43.

The position information acquisition device 50 acquires the current position information of the vehicle VH. For example, a GPS (Global Positioning System), a GNSS (Global Navigation Satellite System), etc. included in a navigation device, not shown, can be used as the position information acquisition device 50. The position information acquisition device 50 transmits the acquired current position information of the vehicle VH to the ECU 10 at a predetermined cycle.

The automatic parking exit switch 60 is, for example, a switch that is provided on a center console, an instrument panel, etc. of the vehicle VH and is turned on or off by an occupant (for example, a driver) of the vehicle VH. When the automatic parking exit switch 60 is turned on, the ECU 10 receives an automatic parking exit start request. The automatic parking exit start request may be received through operation of a touch-type switch image displayed on the display device 71, which will be described later, or through speech recognition etc. by a sound collector, not shown.

The HMI 70 is an interface for transferring data between the ECU 10 and the driver, and includes an input device and an output device. Examples of the input device include a touch panel liquid crystal display, a switch, and a sound pickup microphone. Examples of the output device include a display device 71 and a speaker 72. The display device 71 is, for example, a center display, a multi-information display, or the like. The speaker 72 is, for example, a speaker of an acoustic system or a navigation system.

### Software Configuration

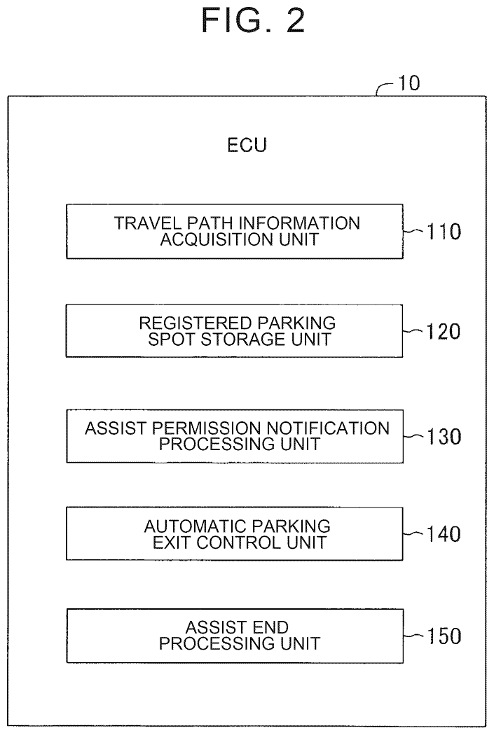

FIG. 2 is a schematic diagram illustrating a software configuration of the parking exit assist device 1 according to the present embodiment. As shown in FIG. 2, the ECU 10 includes a travel path information acquisition unit 110, a registered parking spot storage unit 120, an assist permission notification processing unit 130, an automatic parking exit control unit 140, an assist end processing unit 150, etc. as functional elements. These functional elements 100 to 150 are implemented by the CPU 11 of the ECU 10 loading the programs stored in the ROM 12 into the RAM 13 and executing the program. All or part of the functional elements 100 to 150 may be provided in a separate ECU from the ECU 10 or in an information processing device in a facility (e.g., a control center) that can communicate with the vehicle VH.

In response to a registration start request from the driver, the travel path information acquisition unit 110 acquires travel path information of the vehicle VH when the driver manually maneuvers the vehicle VH to exit the parking spot (parking space) where the vehicle is stopped. Then, the travel path information acquisition unit 110 temporarily stores the acquired travel path information in the RAM 13. The registration start request of the driver may be acquired through, for example, operation of a touch-type switch image displayed on the display device 71, operation of a physical switch provided separately from the display device 71, voice recognition by a sound collector, etc.

The travel path information acquired by the travel path information acquisition unit 110 includes not only a travel path along which the vehicle VH actually travels but also manipulation information such as a vehicle speed, a steering angle, and a shift position. The travel path of the vehicle VH refers to a travel trajectory of a vehicle position that changes as the vehicle VH travels. The vehicle position is, for example, a predetermined geometric center position in a plan view of the vehicle VH. The vehicle position may be another position of the vehicle VH (for example, a center position of the left and right front wheels or a center position of the left and right rear wheels).

When the vehicle VH is stopped, the travel path information acquisition unit 110 sets the position information of the vehicle VH at that time to the start position of the travel path (the exit start position). The position information of the vehicle VH may be acquired on the basis of the position information acquisition device 50. When the start position is set, the travel path information acquisition unit 110 sets, for example, a two-dimensional map in which the origin is the start position, the X-axis is the front-rear direction of the vehicle VH, and the Y-axis is the width direction of the vehicle VH.

When the driver starts manually maneuvering the vehicle from the start position to exit the parking spot, the travel path information acquisition unit 110 plots the travel trajectory of the vehicle position on a two-dimensional map at every predetermined sampling cycles. In this way, it is possible to acquire the travel path of the vehicle VH. The travel trajectory may be calculated, for example, by odometry based on the detection results of the wheel speed sensor 31 and the steering angle sensor 34. Alternatively, the travel trajectory may be used in combination with the position information of the vehicle VH acquired by the position information acquisition device 50. Alternatively, the travel trajectory may be estimated based on an optical flow or the like from images of the road surface around the vehicle VH captured by the camera sensor 43. The predetermined sampling period may be either a predetermined distance or a predetermined time.

When plotting the travel trajectory of the vehicle position on a two-dimensional map, the travel path information acquisition unit 110 acquires the vehicle speed, the steering angle, the shift position, and the like detected by the internal sensor device 30 in association with the vehicle position on the travel path. The travel path information acquisition unit 110 ends acquisition of the travel path information when the drivers stop the vehicle VH at a predetermined position at which the vehicle is unloaded from the parking spot and switch the shift position to parking P. The travel path information acquisition unit 110 sets the vehicle position at the time when the acquisition of the travel path information is completed to the end position (exit completion position) of the travel path.

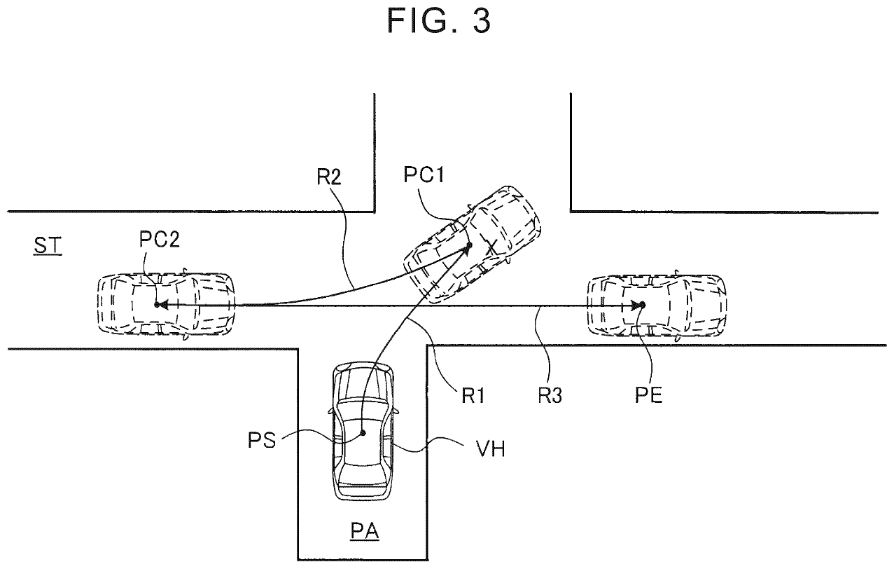

FIG. 3 is a schematic diagram illustrating an example of a travel path of the vehicle VH acquired by the travel path information acquisition unit 110 when the driver manually maneuvers the vehicle VH to exit the parking spot. In FIG. 3, reference numeral PA denotes a parking spot where the vehicle VH is stopped, and reference numeral ST denotes a passage where the parking spot PA faces. FIG. 3 illustrates an exemplary situation in which the drivers move the vehicle VH forward from the parking spot PA and exit the vehicle. Since substantially the same process is performed when the vehicle VH is moved backward and is unloaded from the parking spot PA, description thereof will be omitted.

The exit start position PS in FIG. 3 is the position of the vehicle (the position at which the vehicle is stopped) when the travel path information acquisition unit 110 receives the registration start request from the driver. As shown in FIG. 3, it is assumed that the driver has caused the vehicle VH to travel forward by creeping or accelerator manipulation to a first turning position PC1 in the passage ST while turning from the exit start position PS. Hereinafter, a travel path of the vehicle VH from the exit start position PS to the first turning position PC1 is referred to as a first travel path R1. The travel path information acquisition unit 110 acquires the first travel path R1 by plotting the travel trajectory from the exit start position PS to the first turning position PC1 of the vehicle VH on a two-dimensional map at every predetermined sampling period. Further, the travel path information acquisition unit 110 acquires, for each predetermined sampling period, the vehicle speed, the steering angle, the brake operation amount, the accelerator operation amount, the shift position, etc. of the vehicle VH in association with the vehicle position on the first travel path R1 while the vehicle VH travels in the first travel path R1.

When the driver switches the shift position from drive D to reverse R at the first turning position PC1, the travel path information acquisition unit 110 starts acquisition of the second travel path R2. The second travel path R2 is a travel trajectory until the driver causes the vehicle VH to travel backward from the first turning position PC to a predetermined position in the passage ST and stops the vehicle VH at the predetermined position.

The travel path information acquisition unit 110 acquires the second travel path R2 by plotting a travel trajectory from the first turning position PC1 of the vehicle VH on a two-dimensional map at predetermined sampling periods. In addition, the travel path information acquisition unit 110 acquires, for each predetermined sampling period, the vehicle speed, the steering angle, the brake operation amount, the accelerator operation amount, the shift position, etc. of the vehicle VH in association with the vehicle position on the second travel path R2 while the vehicle VH travels in the second travel path R2. When the driver stops the vehicle VH at a predetermined position and switches the shift position from reverse R to drive D, the travel path information acquisition unit 110 sets the position information of the vehicle VH at that time to the second turning position PC2.

When the driver switches the shift position from reverse R to drive D at the second turning position PC2, the travel path information acquisition unit 110 starts acquisition of the third travel path R3. The third travel path R3 is a travel trajectory until the drivers advance the vehicle VH from the second turning position PC2 to a predetermined position in the passage ST and stop the vehicle VH at the predetermined exit completion position.

The travel path information acquisition unit 110 acquires the third travel path R3 by plotting a travel trajectory from the second turning position PC2 of the vehicle VH on a two-dimensional map at predetermined sampling periods. Further, the travel path information acquisition unit 110 acquires, for each predetermined sampling period, the vehicle speed, the steering angle, the brake operation amount, the accelerator operation amount, the shift position, etc. of the vehicle VH in association with the vehicle position on the third travel path R3 while the vehicle VH travels in the third travel path R3. When the driver stops the vehicle VH at a predetermined position and switches the shift position from drive D to parking P, the travel path information acquisition unit 110 sets the position information of the vehicle VH at that time to the exit completion position PE.

Referring back to FIG. 2, the registered parking spot storage unit 120 stores R3 from the travel path R1 acquired by the travel path information acquisition unit 110 as target travel path RT used for the automatic parking exit control of the parking spot PA. In addition, the registered parking spot storage unit 120 stores the target travel path RT in association with the position data of the parking spot PA. The position information on the parking spot PA may be acquired on the basis of the position information acquisition device 50. When there is a plurality of registered parking spots, the registered parking spot storage unit 120 stores a target travel path RT, position information, etc. for each of the registered parking spots.

When the current position of the vehicle VH is within a predetermined distance from the position of the registered parking spot based on the detection result from the position information acquisition device 50, the assist permission notification processing unit 130 performs a notification process of notifying the driver of the vehicle VH that parking exit assistance in the autonomous driving mode is available. The notification to the driver may be given by, for example, a display on the display device 71 or a sound from the speaker 72.

The assist permission notification processing unit 130 executes the notification processing, and the driver (occupant) of the vehicle VH turns on the automatic parking exit switch 60. In this case, the automatic parking exit control unit 140 executes an automatic parking exit control for automatically operating the drive device 20, the steering system 21, the braking device 22, and the transmission device 23 of the vehicle VH based on the target travel path RT stored in the registered parking spot storage unit 120. The automatic parking exit control is performed by, for example, controlling the operation of the drive device 20, the steering system 21, etc. by feedback control based on the deviation between the target travel path RT and the actual travel trajectory of the vehicle VH. The actual travel trajectory of the vehicle VH may be calculated by odometry based on the findings of the wheel speed sensor 31 and the steering angle sensor 34. Alternatively, the actual travel trajectory of the vehicle VH may be estimated based on an optical flow or the like from the image data of the surrounding road surface of the vehicle VH captured by the camera sensor 43.

After the automatic parking exit control unit 140 starts the automatic parking exit control, the following end conditions (1), (2) are established. Then, the assist end processing unit 150 gives an end permission notification to the driver to notify that the parking exit assistance in the autonomous driving mode can be ended by an accelerator operation or a brake operation (predetermined operation of the present disclosure).
End condition (1): the vehicle VH has reached the exit completion position PE.
End condition (2): the shift position is drive D.
   The notification to the driver may be given by, for example, a display on the display device 71 or a sound from the speaker 72.

When the end conditions (1), (2) are satisfied and an accelerator operation or a brake operation by the driver is acquired, the assist end processing unit 150 ends the parking exit assistance in the autonomous driving mode and switches to the manual driving mode in which driving of the vehicle VH is left to the driver. An accelerator operation may be acquired based on the detection result from the accelerator sensor 32, and a brake operation may be acquired based on the detection result from the brake sensor 33.

When the end condition (1) is satisfied but the end condition (2) is not satisfied, the assist end processing unit 150 ends the parking exit assistance in the autonomous driving mode after forcibly switching the shift position to parking P. That is, when the vehicle VH reaches the exit completion position PE but the shift position is other than drive D (for example, reverse R), the assist end processing unit 150 forcibly switches the shift position to parking P and then ends the parking exit assistance in the autonomous driving mode.

In path storage type parking exit assistance that is used in a frequently used home parking space etc., turning is often included due to the surrounding environment of the parking spot (such as the passage width), and the assist distance tends to be relatively long. Therefore, when the parking exit assistance is continuously executed until the vehicle VH reaches the exit completion position PE, it may make the driver feel annoyed. A possible way to reduce the possibility of making the driver feel annoyed is to allow parking exit assistance to be ended when a predetermined condition is satisfied even through the vehicle VH has not reached the exit completion position PE. However, allowing the parking exit assistance to be ended when the vehicle VH has passed through the position where the vehicle is closest to the object (obstacle) as in the device described in JP 2023-046472 A may result in the case where a turning position is included in the remaining travel path. In this case, the parking exit assistance may end in a situation inconvenient to the driver. The present embodiment improves the convenience of the driver by optimizing the timing to end the parking exit assistance.

Specifically, there is a case where the above end condition (2) is satisfied and the following end conditions (3), (4) are satisfied even before the end condition (1) is satisfied, that is, even before the vehicle VH reaches the exit completion position PE. In this case, the assist end processing unit 150 gives an end permission notification to the driver to notify that the parking exit assistance in the autonomous driving mode can be ended by an accelerator operation or a brake operation.
End condition (3): there is no turning position on the subsequent target travel path RT.
End condition (4): the distance from the current position of the vehicle VH to the exit completion position PE is equal to or less than a predetermined threshold.

When the end conditions (3), (4) are satisfied and an accelerator operation or a brake operation by the driver is acquired, the assist end processing unit 150 ends the parking exit assistance in the autonomous driving mode and switches to the manual driving mode in which the driving of the vehicle VH is left to the driver. A situation inconvenient to the driver, namely a situation in which the parking exit assistance ends early, is less likely to occur. In addition, the parking exit assistance is less likely to continue longer than the driver feels it should. Therefore, the convenience of the driver can be reliably improved.

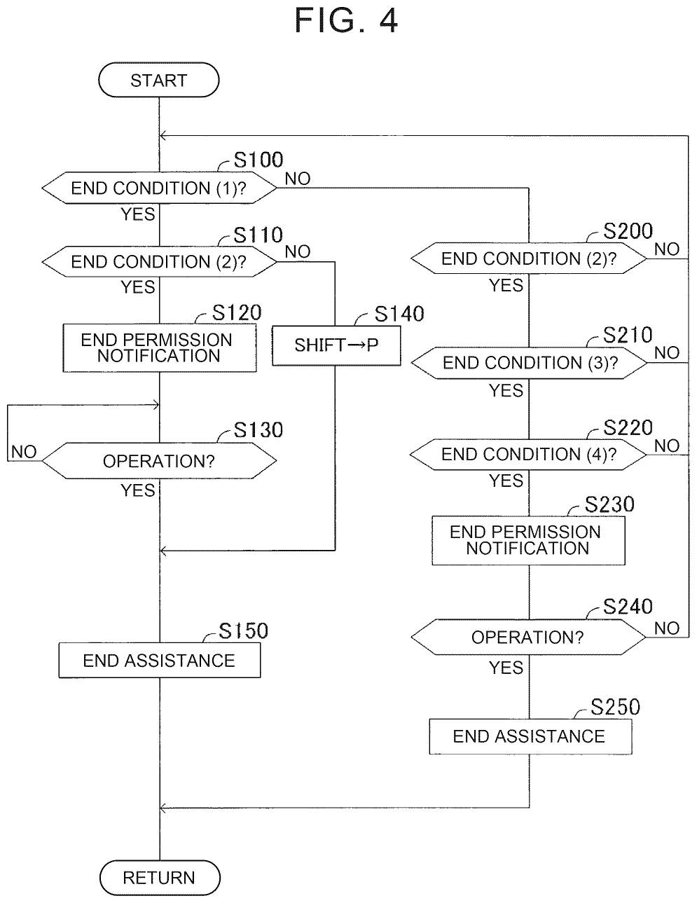

Next, based on the flow chart shown in FIG. 4, a routine of the parking exit assist end process executed by the CPU 11 of the ECU 10 will be described. For example, this routine is started when the automatic parking exit control is executed after the automatic parking exit start request is received from the driver through the operation of turning on the automatic parking exit switch 60.

In S100, the ECU 10 determines whether the vehicle VH has reached the exit completion position PE, that is, whether the above end condition (1) is satisfied. When the vehicle VH reaches the exit completion position PE (Yes), the ECU 10 proceeds to S110. On the other hand, when the vehicle VH has not reached the exit completion position PE (No), the ECU 10 proceeds to S200.

In S110, the ECU 10 determines whether the shift position is drive D, that is, whether the above end condition (2) is satisfied. When the shift position is drive D (Yes), the ECU 10 proceeds to S120. On the other hand, when the shift position is not drive D (No), the ECU 10 proceeds to S140.

In S120, the ECU 10 gives an end permission notification to the driver to notify that the parking exit assistance in the autonomous driving mode can be ended by an accelerator operation or a brake operation. Then, in S130, the ECU 10 determines whether an accelerator operation or a brake operation by the driver has been acquired. When an accelerator operation or a brake operation by the driver is acquired (Yes), the ECU 10 proceeds to S150. On the other hand, when neither an accelerator operation nor a brake operation by the driver is acquired (No), the ECU 10 repeats the determination of S130.

When the process proceeds from S110 to S140, the ECU 10 forcibly switches the shift position to parking P and proceeds to S150.

In S150, the ECU 10 ends the parking exit assistance in the autonomous driving mode, switches to the manual driving mode in which the driving of the vehicle VH is left to the drivers, and then returns.

When the process proceeds from S100 to S200, the ECU 10 determines whether the shift position is drive D, that is, whether the above end condition (2) is satisfied. When the shift position is drive D (Yes), the ECU 10 proceeds to S210. On the other hand, when the shift position is not drive D (No), the ECU 10 returns to S100.

In S210, the ECU 10 determines whether there are no turning positions PC1, PC2 on the target travel path RT from the current position of the vehicle VH to the exit completion position PE, that is, whether the above end condition (3) is satisfied. When the end condition (3) is satisfied (Yes) (that is, when there are no turning positions PC1, PC2), the ECU 10 proceeds to S220. On the other hand, when the end condition (3) is not satisfied (No) (that is, when there is at least one turning position PC1, PC2), the ECU 10 returns to S100.

In S220, the ECU 10 determines whether the distance from the current position of the vehicle VH to the exit completion position PE is equal to or less than a predetermined threshold, that is, whether the above end condition (4) is satisfied. When the distance to the exit completion position PE is equal to or smaller than the predetermined threshold (Yes), the ECU 10 proceeds to S230. On the other hand, when the distance to the exit completion position PE is not equal to or smaller than the predetermined threshold (No), the ECU 10 returns to S100 process. S210 and S220 may be performed in any order, and may be performed simultaneously.

In S230, the ECU 10 gives an end permission notification to the driver to notify that the parking exit assistance in the autonomous driving mode can be ended by an accelerator operation or a brake operation. Then, in S240, the ECU 10 determines whether an accelerator operation or a brake operation by the driver has been acquired. When an accelerator operation or a brake operation by the driver is acquired (Yes), the ECU 10 proceeds to S250. On the other hand, when neither an accelerator operation nor a brake operation by the driver is acquired (No), the ECU 10 returns to S100 process.

In S250, the ECU 10 ends the parking exit assistance in the autonomous driving mode, switches to the manual driving mode in which the driving of the vehicle VH is left to the drivers, and then returns.

The present disclosure is not limited to the above-described embodiments, and various modifications can be made without departing from the scope of the present disclosure.

For example, in the above-described embodiment, the forward exit is exemplified, but the disclosed technique can also be applied to cases where the vehicle VH is moved backward. In the above embodiment, the path storage type parking exit assist device has been described as an example, but the technology of the present disclosure can also be applied to a path setting type parking exit assist device that sets a travel path every time when delivering.

What is claimed is:

1. A parking exit assist device for a vehicle that is configured to execute a parking exit assist control for moving a parked vehicle to a predetermined exit completion position along a travel path stored in advance, wherein the parking exit assist device is configured to, when a specific condition is satisfied before the vehicle under the parking exit assist control reaches the exit completion position, notify an occupant of the vehicle that the parking exit assist control is allowed to be ended by a predetermined operation, and end the parking exit assist control when the predetermined operation is detected, the specific condition being a condition that there is no turning position on the travel path from a current position of the vehicle to the exit completion position and a distance from the current position of the vehicle to the exit completion position is equal to or less than a predetermined threshold, and the turning position being a position where a direction of travel of the vehicle is changed.

2. The parking exit assist device according to claim 1, wherein the specific condition further includes that a shift position of a transmission device of the vehicle is drive.

3. The parking exit assist device according to claim 1, wherein the predetermined operation is either an accelerator operation or a brake operation by a driver of the vehicle.

4. A parking exit assist method for a vehicle that is configured to execute a parking exit assist control for moving a parked vehicle to a predetermined exit completion position along a travel path stored in advance, wherein when a specific condition is satisfied before the vehicle under the parking exit assist control reaches the exit completion position, an occupant of the vehicle is notified that the parking exit assist control is allowed to be ended by a predetermined operation, and the parking exit assist control is ended when the predetermined operation is detected, the specific condition being a condition that there is no turning position on the travel path from a current position of the vehicle to the exit completion position and a distance from the current position of the vehicle to the exit completion position is equal to or less than a predetermined threshold, and the turning position being a position where a direction of travel of the vehicle is changed.
